(19) United States
(12) Patent Application Publication
(10) Pub. No.: US 2010/0008751 A1
(43) Pub. Date: Jan. 14, 2010

(54) BOOM ARRANGEMENT

(76) Inventors: Daniel Webb, New South Wales (AU); Tim Smith, New South Wales (AU)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 12/374,862

(22) PCT Filed: Jul. 17, 2006
(86) PCT No.: PCT/AU07/00990

§ 371 Date: Jan. 23, 2009

(30) Foreign Application Priority Data
Jul. 24, 2006 (AU) 2006903984

(51) Int. Cl. E02F 3/38; B66C 23/64

(52) U.S. Cl. 414/722

(57) ABSTRACT

The present invention provides a lift assembly (10) for lifting an implement via an implement mount (70) relative to a vehicle, the lift assembly (110) including a boom arm (46) and a linkage system (32, 80, 76) for tilting the implement relative to the vehicle, the linkage system including at least one link member (32, 80, 76), the arrangement being such that said at least one link member (32, 80, 76) is substantially housed and or concealed within the boom arm (46).

### FIELD OF THE INVENTION

The present invention relates generally to a lifting system for a vehicle including a pivoting boom arm and a load carrying implement attached to a free end of the boom arm. More particularly, the present invention relates to a linkage system for controlling a position of a load carrying implement of a front end loader relative to a boom arm of the front loader.

### BACKGROUND OF THE INVENTION

Front loaders, also called front end loaders, bucket loaders, scoop loaders etc, are well known in the art. Although the design of front loaders can significantly differ, certain components are common to all front loaders. Thus one of the main components of a front loader is one or more movable boom arms adapted to lift and move material.

To this end, a front loader is typically provided with a tilting bucket connected to the one or more movable arms. The bucket can be replaced with other devices or tools. For example, many front loaders can mount forks to lift heavy pallets or shipping containers.

Typically, a hydraulic cylinder is used to raise and lower the arm(s) relative to a vehicle frame, and another hydraulic cylinder is used to tilt the bucket relative to the boom arm(s).

One of the inherent dangers of a front end loader arises from the fact that the boom arm may rotate nearly 90 degrees relative to the vehicle frame. The bucket attached to the boom arm will also rotate the same angle unless the operator manually adjusts the position of the bucket relative to the arm by using an implement cylinder. If the position of the bucket is not adjusted, the items or material in the bucket are likely to fall onto the operator as the boom arm reaches its full height. It is known to use a mechanical linkage to cause the implement to roll forward an equivalent angle to which the boom arm rolls back.

Any reference herein to known prior art does not, unless the contrary indication appears, constitute an admission that such prior art is commonly known by those skilled in the art to which the invention relates, at the priority date of this application.

### SUMMARY OF THE INVENTION

The present invention provides a lift assembly for lifting an implement relative to a vehicle, the lift assembly including a boom arm and a linkage system for tilting the implement relative to the vehicle, the linkage system including at least one link member, the arrangement being such that at least a portion of said at least one link member is substantially housed and or concealed within the boom arm.

The linkage system can include a bell crank having a drive end and a driven end, the link member can be connected to the drive end.

The linkage system can include a bell crank having a drive end and a driven end, the link member can be connected to the driven end.

The linkage system can include a bell crank, a top link member, and an implement-side link member, with the top link member being the link member which is substantially housed and or concealed within the boom arm.

The linkage system can include a bell crank, a top link member, and an implement-side link member, with the implement-side link member being the link member which is substantially housed and or concealed within the boom arm.

The link members can be wholly or substantially housed or concealed in said boom arm.

At least two members can be substantially housed and or concealed within a single boom arm.

The boom arm can have a frame including a sleeve member.

The top link member can be connected to the bell crank by pivot means, and the boom arm can have a recess or opening formed therein, the recess or opening being adapted to receive at least a portion of the pivot means.

The boom arm can include a frame-side portion and an implement-side portion, the frame-side portion can be pivotably connected to the vehicle frame, the implement-side portion can be pivotably connected to an implement, and wherein the recess or opening is formed in the implement-side portion of the boom arm.

The assembly can further include a mounting structure adapted to engage a receiving structure provided on the frame, the mounting structure including two spaced apart side plates defining a space therebetween, a support member being positioned in the space, the support member being adapted to be pivotably attached to the top link member.

The mounting structure can include a boom pivot means for pivotably connecting a boom arm, the boom arm being pivotable between a first position and a second position, the arrangement being such that there is clearance between the boom arm and a surface of the support member when the boom arm is in the first or second position.

The present invention provides a lift assembly for lifting an implement relative to a vehicle, said lift assembly including a boom arm and a linkage system for tilting said implement relative to said vehicle, said linkage system including at least one link member, the arrangement being such that at least a portion of said link member is substantially concealed within said boom arm at least when the boom arm is moved between a first position and a second position of a lift cycle.

The present invention also provides a lift assembly for lifting an implement relative to a vehicle, said lift assembly including a boom arm and a linkage system for tilting said implement relative to said vehicle, said linkage system including a bell crank having a drive end and a driven end, and a link member connected to said drive end, the arrangement being such that at least a portion of said link member is substantially concealed within said boom arm at least when the boom arm is moved between a first position and a second position of a lift cycle.

The present invention further provides a lift assembly for lifting an implement relative to a vehicle, said lift assembly including a boom arm and a linkage system for tilting said implement relative to said vehicle, said linkage system including a bell crank having a drive end and a driven end, and a link member connected to said driven end, the arrangement being such that at least a portion of said link member is substantially concealed within said boom arm at least when the boom arm is moved between a first position and a second position of a lift cycle.

The present invention provides a lift assembly for lifting an implement relative to a frame of a load elevating vehicle, said lift assembly including a boom arm and a linkage system for tilting said implement relative to the frame of said vehicle, said linkage system including a bell crank, a top link member, and an implement-side link member, the arrangement being such that at least a portion of said top link member is substantially concealed within said boom arm when the boom arm is lifted or lowered between a first position and a second position throughout a lift cycle.

The first position can correspond to the lowest position of the boom arm.

The second position can correspond to the highest position of the boom arm.

The boom arm can have a frame including a sleeve member.

The boom arm can have a frame including a “U”-shaped member or an “L”-shaped member.

The top link member can be connected to the bell crank by pivot means, and said boom arm can have a recess formed therein, said recess being adapted to receive at least a portion of said pivot means.

Alternatively, the boom arm can include an opening adapted to receive at least a portion of said pivot means.

The boom arm can include a frame-side portion and an implement-side portion, said frame-side portion being pivotably connected to the vehicle frame, said implement-side portion being pivotably connected to the implement, and said recess can be formed in the implement-side portion of the boom arm.

Alternatively, said opening can be formed in the implement-side portion of the boom arm.

Preferably, the top link member is substantially concealed within the boom arm when the boom arm is viewed from a side or a top thereof.

In other embodiments of the present invention, the top link member is substantially concealed within the boom arm when the top link member is viewed from a direction substantially perpendicular thereto.

The lift assembly can further include a mounting structure adapted to engage a receiving structure provided on said frame, said mounting structure including a support member and two spaced apart side plates defining a space therebetween, said support being positioned in said space, said support member being adapted to be pivotably connected to said top link member.

The mounting structure can include boom pivot means for pivotably connecting a boom arm, said boom arm being pivotable between a first position and a second position, the arrangement being such that said boom arm abuts against a surface of the support member when said boom arm is in said first or second position.

The present invention also provides a lift arm, said lift arm being adapted to be coupled to a bell crank mechanism including a bell crank and a link, said bell crank including fulcrum pivot means and link pivot means, said lift arm having a recess or an opening formed therein, said recess or said opening being adapted to receive at least a portion of said link pivot means.

The present invention further provides a load elevating vehicle including: a frame; a lift arm; a lift cylinder for moving said lift arm between an upper position and a lower position, said lift cylinder being pivotably connected to said lift arm; tilt cylinder means for tilting said implement between a first position and a second position, said tilt cylinder means being pivotably connected to said lift arm, and a linkage system for tilting said implement relative to the frame of said vehicle, said linkage system including a bell crank, a top link member, said top link member being pivotably connected to said frame, and an implement-side link member, said implement-side link member being attached to said tilt cylinder, the arrangement being such that at least a portion of said top link member is substantially concealed within said lift arm.

The present invention also provides a loader linkage for controlling an angular position of an implement relative to a frame of a load elevating vehicle, said loader linkage including: a boom having a loader-side portion and an implement-side portion, the loader-side portion of the boom being pivotably connected to the frame of the vehicle; and a bell crank arrangement including: a bell crank pivotably connected to the implement-side portion of the boom and having a drive end and a driven end, a levelling link having a first end and a second end, said first end being pivotably connected to the frame of the vehicle, and an implement-side link, the arrangement being such that the drive end of the bell crank is pivotably connected to the second end of the levelling link, and the driven end of the bell crank is pivotably connected to said implement-side link for controlling the angular position of the implement relative to the boom.

The present invention further provides a process of assembling a lift assembly for lifting an implement relative to a vehicle, said lift assembly including a boom arm and a linkage system for tilting said implement relative to the vehicle, said linkage system including at least one link member, the process including the step of positioning at least a portion of the link member inside the boom arm.

### BRIEF DESCRIPTION OF THE DRAWINGS

An embodiment or embodiments of the present invention will now be described, by way of example only, with reference to the accompanying drawings, in which:

FIG. 1 is a side elevation view of a front end loader equipped with a linkage system, whereby the boom stands in its lowest position;

FIG. 2 is a side cross-sectional view of a front end loader equipped with the linkage system shown in FIG. 1;

FIG. 3 is a side cross-sectional view similar to that in FIG. 2, whereby the boom stands in a higher position;

FIG. 4 is a side cross-sectional view similar to that in FIG. 3, whereby the boom stands in its highest position;

FIG. 5 is an enlarged fragmentary view corresponding to a portion of FIG. 2;

FIG. 6 is an enlarged fragmentary view corresponding to a portion of FIG. 4;

FIG. 7 is an enlarged fragmentary perspective view of a portion of the linkage system of FIG. 1;

FIG. 8 is an enlarged fragmentary perspective view of a bell crank arrangement of the linkage system of FIG. 1;

FIG. 9 is a fragmentary perspective view of an internally housed bell crank; and

FIG. 10 is a cut-away view of the components of FIG. 9.

### DETAILED DESCRIPTION OF THE EMBODIMENT OR EMBODIMENTS

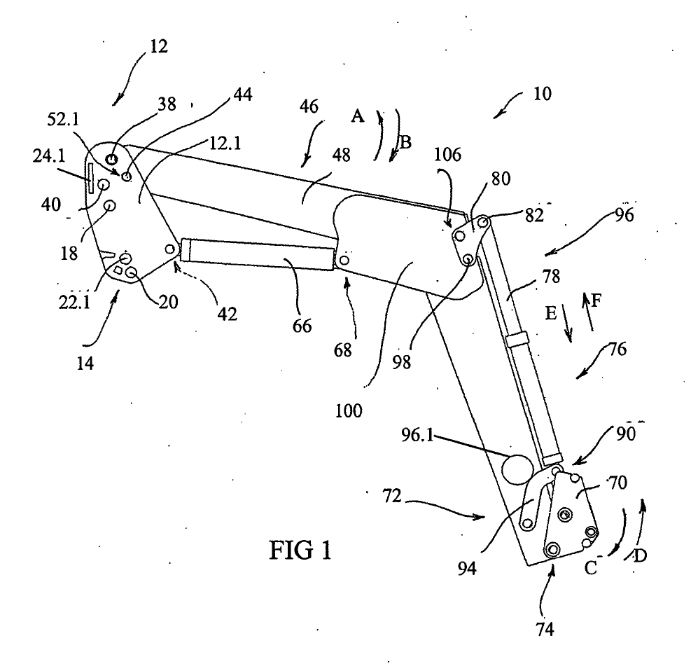

Illustrated in FIGS. 1 to 4 is a front loader 10 removably attachable to a vehicle frame (not shown). The front loader 10 is usually comprised of two boom arms which are secured together by a cross bar (which may be cylindrical, square or rectangular in cross section) to carry an implement on an implement mount pivotally connected to the end of the boom arms. For convenience the description below will refer to one boom arm, but is applicable to both boom arms.

To this end, the front end loader 10 is provided with a front end loader top post 12 and a locking device 14 attached thereto. A front end loader bottom post (not shown) is erected on a support member (not shown) projecting outwardly of a vehicle frame.

The front end loader top post 12 includes a pair of side plates 12.1 and 12.2. The plates 12.1 and 12.2 are vertically oriented and substantially parallel to each other. The side plates 12.1 and 12.2 are spaced apart from each other so as to define a space 16 therebetween.

Extending between the side plates 12.1 and 12.2 are two connecting elements 18 and 20, with the top connecting element being the mounting pin 18 and the bottom element being the bearing pin 20, each pin having a horizontal axis. The pins 18 and 20 can be welded or otherwise fixed to the side plates 12.1 and 12.2. The mounting pin 18 and the bearing pin 20 are adapted to releasably engage complementary portions of the bottom post (not shown).

Each side plate 12.1 and 12.2 is provided with an aperture 22.1 and 22.2 extending transversely therethrough for rotatably receiving a locking member of the locking device 14.

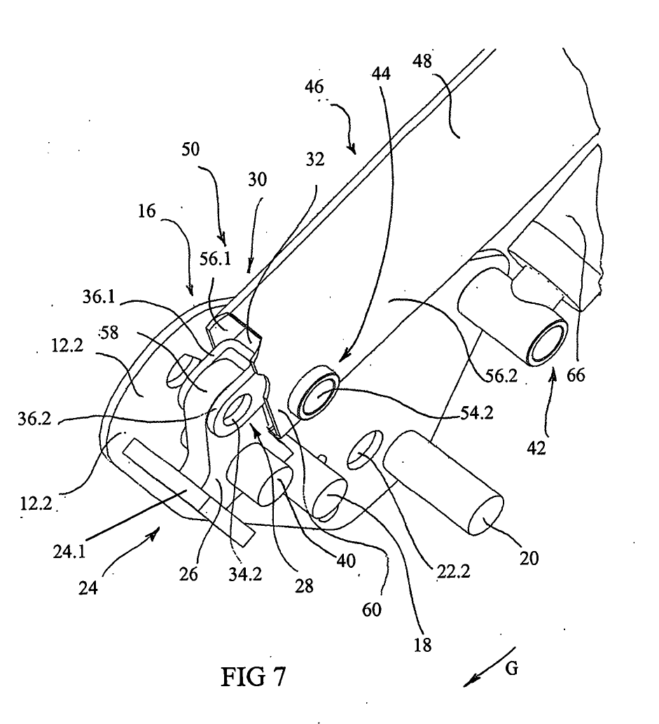

As best shown in FIG. 7, disposed between the side plates 12.1 and 12.2 is a support member 24 which includes a wall portion 26 having an aperture 28 defined therein, and a pin 40 extending in opposite directions therefrom, together with a transverse rearwardly locate member 24.1 which is of a generally rectangular prismatic construction. The transverse member 24.1, and the opposite ends of the pin 40 allow the support member to be welded to and securely held in place between the side plates 12.1 and 12.2. The support member can be manufactured by fabrication same from plate components, however, a more preferred manufacturing method is to make the support member as a cast steel component.

A rear end 30 of a top link member 32 is positioned within the space 16 such that the aperture 28 formed in the wall portion 26 is linearly aligned with a top link pin bore 34.1 (not shown) formed in a left proximal extension 36.1 and a top link pin bore 34.2 formed in a right proximal extension 36.2 (as viewed in the general direction of arrow G in FIG. 7). A pin (not shown) is then inserted through holes 28, 34.1, and 34.2 so as to pivotally couple the top link member 32 to the wall portion 26 of the support member 24 to thereby provide top link pivot 38.

The support member 24 is attached to the side plates 12.1 and 12.2 of the support post 12 by a pin 40 extending through an aperture (not shown) defined in the wall portion 26 of the support member 26. The pin can be welded and fixed in to the side plates 12.1 and 12.2 and the support member 26.

The top post 12 further includes two pivots: lift cylinder pivot 42 and boom pivot 44.

Pivotably connected to an upper end of the front end loader top post 12 by the boom pivot 44 is a boom arm 46. As best illustrated in FIG. 7, the boom arm 46 includes a frame member 48. The frame member 48 can be in the form of a sleeve. It will be appreciated by those skilled in the art that the boom arm 46 can include an “U” or “L”-shaped frame member, an inverted “U” or “L”-shaped frame member, etc.

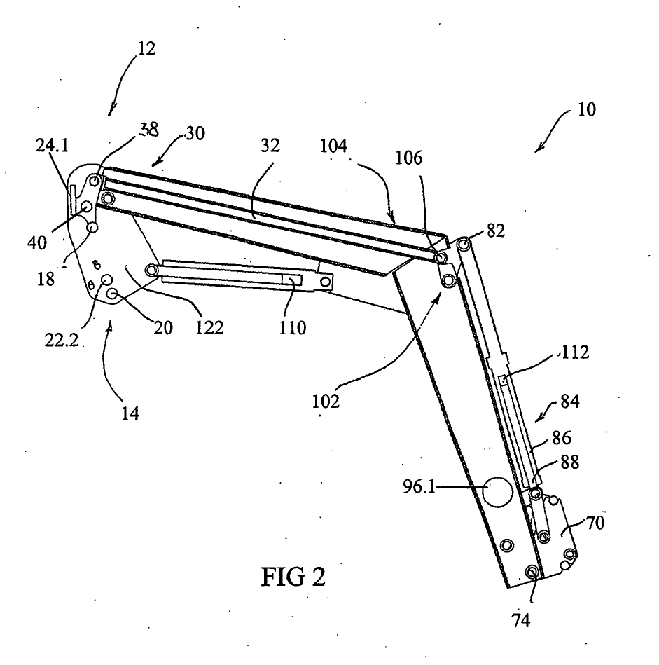

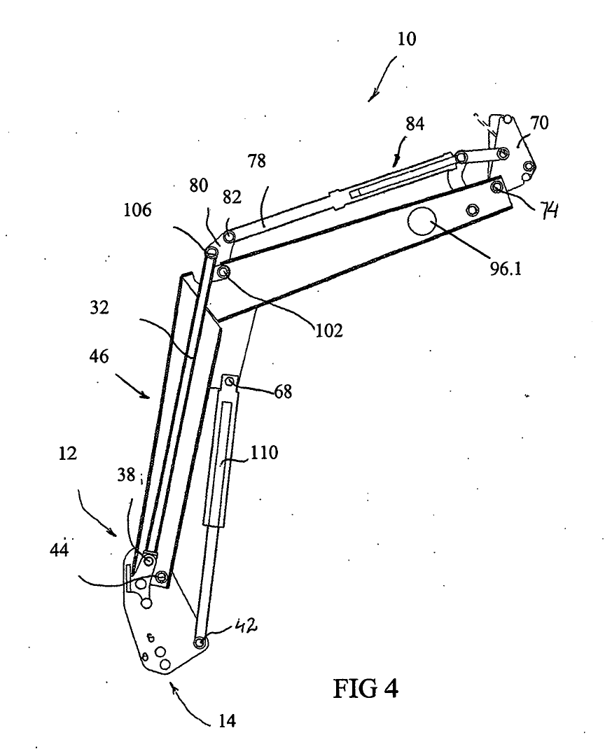

The frame member 48 is sized and shaped to receive or house a top link member 32 of the front loader 10, the arrangement being such that the top link member 32 is substantially housed and or concealed within the frame 48 when the boom 46 of the front loader 10 is lifted or lowered between a first position and a second position throughout a lift cycle. Preferably, the first position corresponds to the lowest position of the boom arm 46 (see FIG. 2), and the second position corresponds to the highest position of the boom arm 46 (see FIG. 4), or vice versa.

The top link member 32 can also be substantially housed within the frame member 48 and is concealed when the boom arm 46 is viewed from a side thereof and or a top thereof.

Alternatively the top link member 32 can be substantially housed within the boom arm 46 when the top link member 32 is viewed from a direction substantially perpendicular thereto.

As best illustrated in FIG. 7, a rear end 50 of the boom arm 46 is positioned within the space 16 such that apertures 52.1 and 52.2 (not shown) formed in the side plates 12.1 and 12.2 respectively are linearly aligned with a sleeve bore 54.1 formed in left side wall 56.1 and sleeve bore 54.2 formed in right side wall 56.2 (as viewed in the general direction of arrow G in FIG. 7). A pin (not shown) is then inserted through holes 52 and 54 so as to pivotally couple the boom 46 to the top post 12 to thereby provide the boom pivot 44.

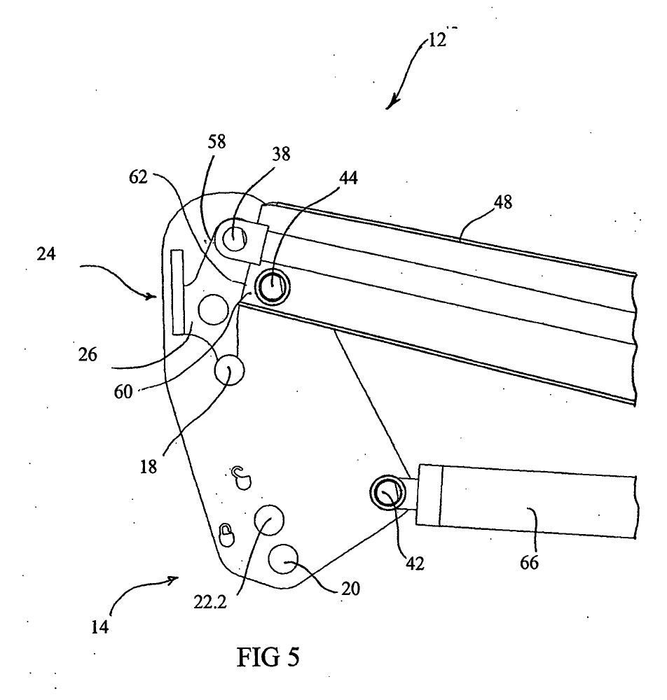

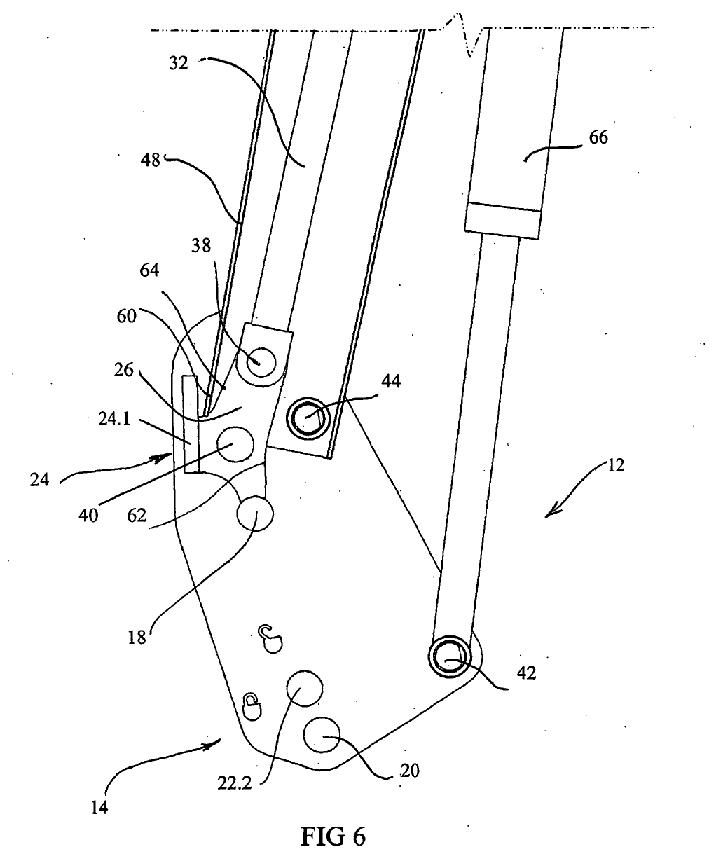

As best illustrated in FIGS. 5 and 6, an upper surface 58 of the wall portion 26 of the support member 24 is shaped is sized to allow rotation of the sleeve member 48 around the pivot point 44 from a first position wherein a rear end 60 of the sleeve member 48 faces a side surface 62 of the support member 24 (see FIG. 5) to a second position wherein the rear end 60 of the sleeve member 48 faces a surface 64 of the support member 24 (see FIG. 6), the arrangement being such that there is clearance between the rear end 60 and the respective surface of the support member 24.

A lift cylinder 66 is connected to the front end loader top post 12 by the pivot 42 and to the boom 46 by pivot 68. The lift cylinder 66 is used to lift and lower the boom 46 in a vertical plane, as indicated by arrows A and B in FIG. 1.

A bucket or implement mount 70 is pivotably connected to a distal end 72 of the boom 46 by pivot 74 providing pivotal movement of the bucket or implement mount 70 in a suitable angular range.

An implement cylinder means 76 (which an also be called a crowd and or dump cylinder—and could also be called a tilt cylinder) extends between the bucket or implement mount 70 and an implement-side link member 78 (generally a piston), the implement-side link member 78 being part of the cylinder means 76.

The implement cylinder means 76 is used to turn the bucket or implement mount 70 upwardly and downwardly in a vertical plane, as indicated by arrows C and D in FIG. 1. To achieve this, the implement cylinder means 76 includes a hydraulic cylinder 84 having a housing 86, piston means and at least one piston rod 88 connected thereto.

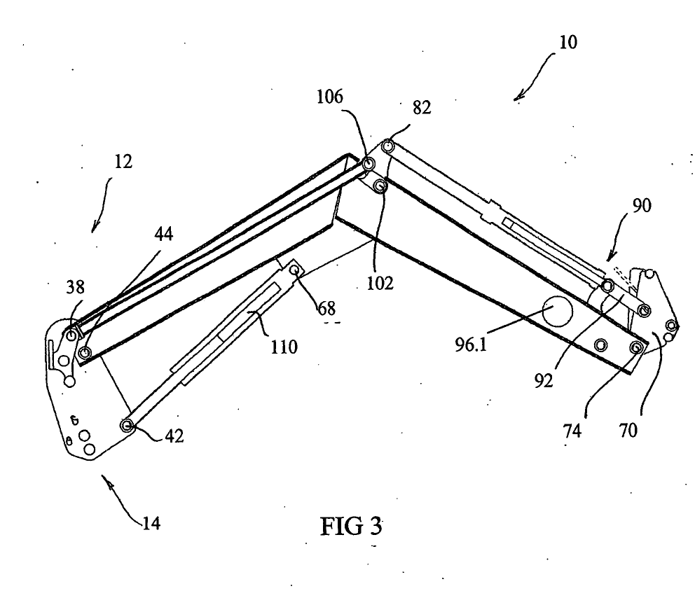

As best illustrated in FIG. 3, an implement end 90 of the piston rod 88 of the cylinder means 76 is pivotably connected to the mount 70 via a link 92.

As shown in FIG. 1, the implement end 90 of the piston rod 88 of the cylinder means 76 is also pivotably connected to the distal end 72 of the boom 46 via a link 94.

By virtue of the fact that the link member 78 and the cylinder 84 are mechanically connected, the advance and retraction of the piston rod 88 causes movement of the mount 70 in direction indicated by arrows C and D in FIG. 1. As a result of the foregoing, the cylinder 84 can be used to achieve a scoop/dump function of the mount 70. The cylinder 84 operates exactly the same as a conventional implement cylinder (i.e. controlling the position/angle of the bucket or implement mount 70) and will be referred to as a “crowd cylinder” 84.

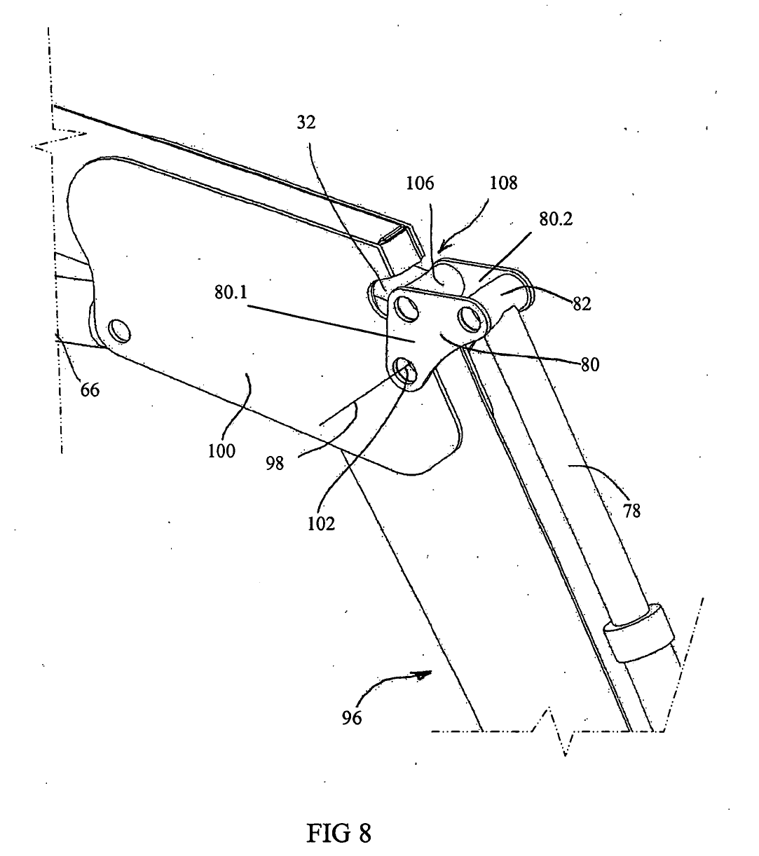

As best illustrated in FIG. 8, the bell crank 80, is constructed from two generally triangular or L-shaped plates 80.1 and 80.2 which are spaced apart by means of pins which form a bell crank rotation axis 98, and pivots 82 and 106. The bell crank 80 is pivoted about the bell crank axis 98 to the implement-side portion 96 of the boom arm 46. The crank axis 98 extends horizontally and transversely with respect to the direction of vehicle travel. The bell crank 98 is such that the two plates 80.1 and 80.2 are pivotably connected to a plate 100 (a similarly shaped plate is located on the other side of the boom 46) and the implement side portion 96 of the boom arm 46 by the pin 102. Pivotably attached to the bell crank 80 are the top link member 32 by pivot 106 and the implement-side link member 78 by pivot 82.

As best illustrated in FIG. 2, a front end 104 of the top link member 32 is attached to the bell crank 80 by pivot 106. The rear end 30 of the top link member 32 is attached to the support member 24 by the link pivot 38.

The implement-side link member 78 is pivotably connected to the bell crank 80 by pivot 82.

As best illustrated in FIG. 8, the implement side portion 96 of the boom arm 46 and a portion of the plate 100 are provided with coterminous recesses 108.1 and 108.2 adapted to receive the pivot 106 of the top link member 32. It will be appreciated by those skilled in the art that depending on the thickness of the upper wall of the sleeve or frame member 48, an opening in the upper wall of the sleeve or frame member 48 can be used instead of the recess 108. When the boom stands in its lowest position, there is a slight clearance between the pivot 106 of the top link member 32 and the recess 108.

When it is desired to lift the boom arm 46 with the bucket or implement mount 70, the oil from pump means (not shown) flows into the piston-side chamber 110 of the lift cylinder 84 causing it to extend, as is illustrated in FIGS. 3 and 4.

As a result, the boom arm 46 rotates anticlockwise in FIGS. 2 to 4. Since the pivot 102 forms the fulcrum of the bell crank 80, the rotation of the boom arm 46 causes a corresponding rotational movement of the bell crank 80. The top link member 32 and the implement-side link member 78 follow the rotation of the bell crank 80 so that the top link member 32 rotates around the pivot point 38 anticlockwise in FIGS. 2 to 4, pushing the link member 78 in a direction indicated by arrow E.

This movement of the link member 78 causes the mount 70 to rotate around the pivot 74 clockwise in FIGS. 2 to 4. As a result, as the boom arm 46 of the front loader 10 raises up, the bell crank arrangement of the front loader creates a level lift by tilting the bucket or implement mount 70 in response to the upward turning of the boom arm 46 so as to maintain the bucket or implement mount 70 attached to the boom arm 46 always substantially horizontal.

When the boom arm 46 is lowered, the boom arm 46 rotates clockwise in FIGS. 2 to 4. The rotation of the boom arm 46 causes a corresponding movement of the bell crank 80 so that the top link member 32 rotates around the pivot point 38 clockwise in FIGS. 2 to 4, pulling the link member 78 in a direction indicated by arrow F. This movement of the link member 78 causes the bucket or implement mount 70 to rotate around the pivot 74 anticlockwise in FIGS. 2 to 4. As a result, as the boom arm 46 of the loader 10 is lowered, the bell crank arrangement tilts the bucket or implement mount 70 in response to the downward turning of the boom arm 46 so as to maintain the bucket or implement mount 70 attached to the boom arm 46 always substantially horizontal.

When it is desired to move the bucket or implement mount 70 to a dump position, oil from pump means (not shown) flows into the piston-side chamber 10 of the crowd cylinder 84 so that the rod 88 of the crowd cylinder 84 is extended to cause the bucket or implement mount 70 to perform the dump action. When it is desired to move the bucket or implement mount 70 into a scoop position, the operation proceeds in an analogous manner but in this case since the direction of supply of oil to the crowd cylinder 84 is reversed, the rod 88 of the cylinder 84 is retracted, thus causing the bucket or implement mount 70 to perform the scoop action.

As a result, the dump/scoop function performed by the crowd cylinder 84 and the levelling function performed by the bell crank arrangement are independent of each other.

The lift assembly of described above is assembled as follows. The link member 32 is positioned inside the boom arm 46, and then both the link member 32 and the boom arm 46 are pivotally connected to the support post 12 at 38 and 44 respectively. Alternatively, the link member 32 is pivotally attached the support member 24 at 38, and the boom arm 46 is then attached to the top post 12, the arrangement being such that the link member 32 is positioned inside the boom arm 46.

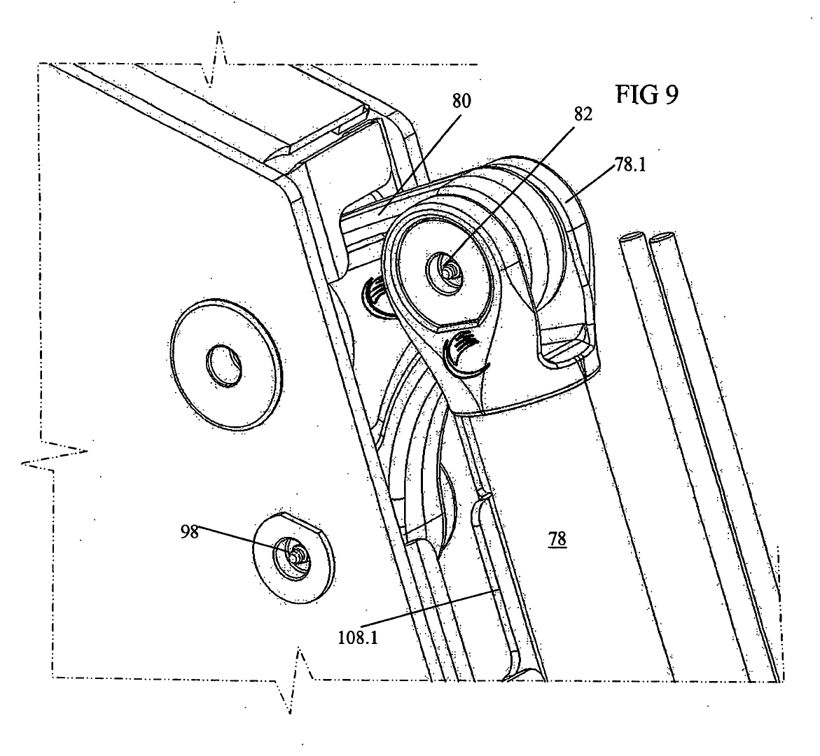

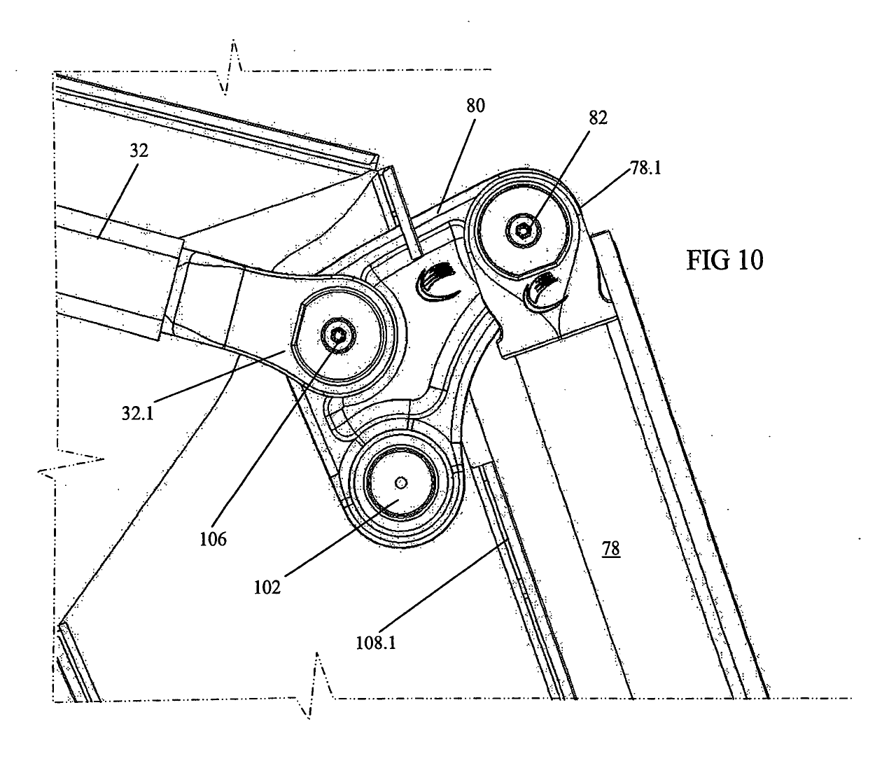

Illustrated in FIGS. 9 and 10 is an internally pivoted bell crank 80, which is pivotally connected to a bifurcated yoke 78.1 on the end of the implement-side link member 78, and is pivotally connected to top link member 32 by a bifurcated yoke 32.1. The bell crank 80 is pivoted to the boom by pin 102 which provide rotation axis 98. The bell crank 80 of FIGS. 9 and 10 differs from that of the previous figures by its being internally housed with respect to the boom 46, but to all intents and purposes operates the same way as the bell crank 80 of other figures. An advantage of the internal housing of the bell crank 80 of FIG. 9 is that the recess 108 is not required in the side walls of the boom 46. However, a cut out portion 108.1 (see FIGS. 9 and 10) is provided in the upper forward surface of the implement side portion 96, to allow a full range of rotation of the bell crank 80 of FIGS. 9 and 10.

If desired the bell crank 80 can be wholly located within the boom arm 46, with the implement cylinder 76 located inside of the implement side of the boom arm 46 to rotatably connect to the link 94 to provide a level lift system. However, such an improvement would require the removal or modification of cylindrical cross member 96.1 which interlinks an adjacent boom arm and holds them rigidly together so as to function as a single boom. In this instance, the top link and the bell crank and the implement cylinder would all be located within the boom.

It can be seen from the figures in respect of the arrangements described above that the top link member 32 is generally oriented so that its longitudinal axis is generally or substantially parallel to the longitudinal axis of the portion 48 of the boom arm 46 in which is it located. This would also be the arrangement of the implement cylinder 76 if it were located within the lower portion of the boom arm 46 in that its longitudinal axis would also be located generally or substantially parallel to the axis of this portion of the boom arm 46.

It will be understood that the invention disclosed and defined herein extends to all alternative combinations of two or more of the individual features mentioned or evident from the text. All of these different combinations constitute various alternative aspects of the invention.

While particular embodiments of this invention have been described, it will be evident to those skilled in the art that the present invention may be embodied in other specific forms without departing from the essential characteristics thereof The present embodiments and examples are therefore to be considered in all respects as illustrative and not restrictive, and all modifications which would be obvious to those skilled in the art are therefore intended to be embraced therein.

1. A lift assembly for lifting an implement relative to a vehicle, said lift assembly including a boom arm and a linkage system for tilting said implement relative to said vehicle, said linkage system including at least one link member, the arrangement being such that at least a portion of said link member is substantially housed and or concealed within said boom arm.

2. A lift assembly as claimed in claim 1, wherein said linkage system includes a crank having a drive end and a driven end, said link member being connected to said drive end.

3. A lift assembly as claimed in claim 1, wherein said linkage system includes a crank having a drive end and a driven end, said link member being connected to said driven end.

4. A lift assembly as claimed in claim 1, wherein said linkage system includes a crank, a top link member, and an implement-side link member, with said top link member being said link member which is substantially housed and or concealed within said boom arm.

5. A lift assembly as claimed in claim 1, wherein there is more than one link member substantially housed or concealed within said boom arm.

6. A lift assembly as claimed in claim 1, wherein said boom arm has a frame including a sleeve member.

7. A lift assembly as claimed in claim 5, wherein said top link member is connected to the crank by pivot means, and said boom arm has a recess or opening formed therein, said recess or opening being adapted to receive at least a portion of said pivot means.

8. A lift assembly as claimed in claim 7 wherein said boom arm includes a frame-side portion and an implement-side portion, said frame-side portion being pivotably connected to the vehicle frame, said implement-side portion being pivotably connected to an implement, and wherein said recess or opening is formed in the implement-side portion of the boom arm.

9. A lift assembly as claimed in claim 4, further including a mounting structure adapted to engage a receiving structure provided on said frame, said mounting structure including two spaced apart side plates defining a space there between, a support member being positioned in said space, said support member being adapted to be pivotably attached to said top link member.

10. A lift assembly as claimed in claim 9, wherein said mounting structure includes boom pivot means for pivotably connecting a boom arm, said boom arm being pivotable between a first position and a second position, the arrangement being such that there is clearance between said boom arm and a surface of said support member when said boom arm is in said first or second position.

11. A lift assembly as claimed in claim 1, wherein said at least one link member is wholly housed and or concealed with said boom arm.

12. A lift arm, which is adapted to be coupled to a crank mechanism including a crank and a link, said crank including fulcrum pivot means and link pivot means, said lift arm having a recess or opening formed therein, said recess or opening being adapted to receive at least a portion of said link pivot means.

13. A load elevating vehicle including: a frame; a lift arm; a lift cylinder for moving said lift arm between an upper position and a lower position, said lift cylinder being pivotably connected to said lift arm; tilt cylinder means for tilting said implement between a first position and a second position, said tilt cylinder means being pivotably connected to said lift arm, and a linkage system for tilting said implement relative to the frame of said vehicle, said linkage system including a crank, a top link member, said top link member being pivotably connected to said frame, and an implement-side link member, said implement-side link member being attached to said tilt cylinder, the arrangement being such that at least a portion of said top link member is substantially concealed and or housed within said lift arm.

14. A loader linkage for controlling an angular position of an implement relative to a frame of a load elevating vehicle, said loader linkage including:
a boom having a loader-side portion and an implement-side portion, the loader-side portion of the boom being pivotably connected to the frame of the vehicle;
a crank arrangement including:
a crank pivotably connected to the implement-side portion of the boom and having a drive end and a driven end,
a levelling link having a first end and a second end, said first end being pivotably connected to the frame of the vehicle, and
an implement-side link,
the arrangement being such that the drive end of the crank is pivotably connected to the second end of the levelling link, and the driven end of the crank is pivotably connected to said implement-side link for controlling the angular position of the implement relative to the boom.

15-19. (canceled)

20. A lift assembly as claimed in claim 1 wherein said crank is a bell crank.
